(19) United States
(12) Patent Application Publication
(10) Pub. No.: US 2018/0053226 A1
(43) Pub. Date: Feb. 22, 2018

(54) Interactive signage and vending machine for change round-up

(71) Applicants: Jay Hutton, Langley (CA); Tim Huckaby, Carlsbad, CA (US); Michael Dershem, Voorbees, NJ (US)

(72) Inventors: Jay Hutton, Langley (CA); Tim Huckaby, Carlsbad, CA (US); Michael Dershem, Voorbees, NJ (US)

(21) Appl. No.: 15/731,333

(22) Filed: May 26, 2017

Related U.S. Application Data
(63) Continuation of application No. 14/757,007, filed on Nov. 6, 2015.
Application No. 14/757,007 is a continuation of application No. 14/120,234, filed on May 9, 2014, now Pat. No. 9,202,331.
Application No. 14/120,234 is a continuation of application No. 13/134,411, filed on Jun. 7, 2011, now Pat. No. 8,755,934.
(60) Provisional application No. 62/392,439, filed on May 31, 2016.
(60) Provisional application No. 61/398,182, filed on Jun. 22, 2010.

(51) Int. Cl. G06Q 30/02; G06Q 20/18; G06Q 20/20

(52) U.S. Cl. CPC G06Q 30/0279; G06Q 20/18; G06Q 20/202

(57) ABSTRACT

Systems and methods employing unique optics, combined with data gathering techniques that capture user interaction in the system at the point of engagement and point of entry. This facilitates gathering real time data on users, customers or other people during engagement with elements of the system to provide analytics in real time. The systems and methods also facilitate contributions for charities.

### CLAIM OF BENEFIT

This application claims the benefit of provisional patent application 62/392,439 filed on May 31, 2016 entitled INTERACTIVE SIGNAGE AND DATA GATHERING TECHNIQUES, the teachings of which are incorporated herein by reference as if specifically set forth below, and provisional patent application 62/499,366 filed on Jan. 23, 2017 entitled INTERACTIVE SIGNAGE AND VENDING MACHINE FOR CHANGE ROUND-UP, the teachings of which are incorporated herein by reference as if specifically set forth below.

### RELATED APPLICATIONS

This is a continuation-in-part of U.S. Provisional Application 62/392,439, Interactive Signage and Data Gathering Techniques filed on May 31, 2016, and a continuation-in-part of U.S. patent application Ser. No. 14/757,007, Vending Machine for Change Round-Up, filed on Nov. 6, 2015.

### FIELD OF THE DISCLOSURE

This disclosure relates to signage for industry, and more specifically to digital signage that provides interactivity for users or customers of modalities that make use of the signage. More particularly, this disclosure relates to digital signage, and ancillary or connected machines, products, services and advertising, for example, and allows for data gathering and data reduction for all aspects of the interactivity or interactions with the signage.

### BACKGROUND OF THE DISCLOSURE

For almost two decades there has been a migration of advertising spend away from broadcast media to other forms of advertising. This is largely due to the on-demand nature of television viewing which allows viewers to fast forward through advertising messages. Today, users and customers are continually inundated during their shopping and traveling experience with the myriad of products and services that are available for purchase in stores, in vending machines, and in areas such as casinos and protected environments that require secure commerce, e-commerce and other user or customer interactions with the environments. Heretofore, there has not existed in the art an integrated and coherent platform by which advertisers and sellers of the products and services can reach customers to efficiently provide their products and services, as well as to gather relevant information about the customers purchasing them. There simply has not been a way, nor have the modalities existed, to efficiently and rapidly facilitate and gather meaningful and readily usable real time data on people, for example, their identities ages, genders, ethnicities, dwell times, emotional recognition, and security threats.

Advertisers are therefore constantly looking for other ways to gain the attention of their audiences and have shifted the limited available marketing to other forms of advertising. The Internet has been the principal benefactor of this shift in recent years, not only because it has become the shopping mall of the future, but because it offers unique abilities to track consumers and develop a comprehensive database about both the general and specific buying behaviors of customers. Moreover, the focus on capturing the “out of home” shopper has also grown considerably, and the desire to grab the attention of consumers when they are not at home and, ideally, closer to a location where they might be influenced by a call to action, is increasing dramatically in attempts to capture these spending opportunities. In store advertising is attractive to advertisers that have consumer brands because their audience will receive the advertising or promotion at a location where the consumer can make a decision to purchase. This makes the advertising impression delivered at retail outlets more impactful and, therefore, more lucrative. Non-digital forms of advertising such as shelf hangers and floor mats are common in retail, but digital advertising, including signage, is not. This limits the abilities of the retailers to capture the attention of consumers in real time, and these lost opportunities result in lost sales that cannot be recaptured.

Many industries suffer from these and other lost opportunities as a result of the inadequate exploitation of digital signage, and the lack of hardware, software and other implementations that could provide a solution to this problem. For example, in the beverage and food industries, beverage, food and freezer units have transparent glass that retailers are loathe to block with advertising promotions. In order to turn this glass real estate into a lucrative platform there would have to be a technology that would allow for advertising (preferably digital) while maintaining the transparency of the platform, thereby allowing for products to be visible simultaneous to the advertising promotion. This currently does not exist in the art.

In the alcoholic beverage retail environment, for example liquor stores are continuously plagued by theft at retail. Higher end spirits and wine are particularly impacted, and the industry's response in past has been simply to lock up expensive product at the retail locations. Thus, customers wishing to purchase product behind lock up have to signal an attendant to gain access to the locked cabinet. While this is a logical way to deal with the theft problem, the unintended consequence of this tactic is that sales velocity (the rate at which product is sold at retail) is enormously and catastrophically impacted. Today, there does not exist an effective monitoring system that allows the industry to manage this problem.

Similarly, the casino industry all over the world is exploding and along with this nearly unmanageable growth, there has developed a series of challenges that casino operators have to navigate. On the regulatory side of these challenges, virtually all casino operators in the US are required to keep and maintain a “Disassociated Persons” (DAP). This DAP List is a record of all gamblers who have enrolled themselves in a program administered state by state for problem gamblers that grant the authorities the right to remove them from any casino property. If a DAP list enrollee gains access to a property only to gamble and lose money the operator is required to return the funds lost as well as face fines for not enforcing the DAP list. In addition to the regulatory threat of DAP list persons on the property, casino operators routinely face risk with respect to known criminals, banned individuals, or persons that local or federal law enforcement may be looking for. Today, casinos invest many millions of dollars in state of the art security systems that cover every inch of the property with CCTV as well as other forms of access control and security. The camera feeds are analyzed against physical photos of the individuals that the casino might be looking for and when a person of interest is observed the casino will act quickly to remove that person from the property, or take whatever actions might be necessary. The whole system has a weak link, that is, the human dependency for implementation of these measures. A security person not only has to be able to sift through multiple live video feeds but also be able to remember the pictures of what could be multiple individuals that are on the watch list. The system is prone to error and leads to enormous cost. Again, the art has not developed sufficient ways to address this problem.

In other commercial areas, for example, loyalty programs are becoming more common in various types of retail environments. These programs generally work on the concept that, upon check out, a loyalty identifier (ID) is provided and associated with the sale. The retailer is provided enormous amounts of data, including buying characteristics, brand alignment, and cross reference data points, during this process which could be enormously useful to the retailer. The primary problem with this approach is that the data is not correctly, efficiently or timely provided, and the identity or affinities of the customer is not established, until the person checks out. With no identity established until the person checks out there is no opportunity to market products or services to that person while they are in store and have the current opportunity inclination to make additional or other buying decisions.

In all of the aforementioned retail, entertainment and other public environments, the world is becoming less secure. The most dangerous spaces, at least from a terrorism point of view, are locations that are open to the public as gathering places or are general hubs of activity. Transport hubs, sports venues, shopping malls, and public squares are just a few examples of locations that represent risk to the general public and opportunity for terrorists. There is an enormous public dialogue about how to make these locations more secure while still allowing freedom of assembly and movement. CCTV networks are a critical part of the solution but have serious restrictions. As mentioned above, CCTV camera networks and systems involve human dependency issues as well as an angle of attack issue. The former relates to the fact that human beings must monitor video feedback from many different cameras, and the latter is a result of the positioning of many of these cameras in high postings that may be looking down on people and, therefore, unable to clearly observe and record their faces. A solution that would augment CCTV and provide a more scale-able way to scan crowds is desperately required.

There is a great need also in our society to donate to charities, and to facilitate donations to charities. Heretofore, vending machines have not in any way been utilized to accomplish this laudable and socially useful set of goals.

There are many manual processes that take place at the point of sale (POS) today but no such mechanism exists whereby chartable, alternative or additional disbursements can take place. For instance, in a local convenience store after purchasing a soda, the consumer may have $0.50 change if they handed $2.00 to a cashier in fulfillment of a $1.50 payment for the item. Oftentimes there are “Charity Buckets” or coin cards to the side of the register where the consumer can simply drop the change as a donation. There is also a type of POS transaction wherein the clerk asks if a certain dollar amount may be put towards a certain charity. Nothing is done like this on vending machines, and there is a need in the art for a vending machine that can facilitate charitable donations from a consumer of the goods or services sold by the vending machine.

These and other issues and problems have not heretofore been addressed or solved in the art.

### SUMMARY

The aforementioned problems are solved, and long-felt needs met, by the present principles by the provision of a system employing unique optics, combined with data gathering techniques that capture user interaction in the system at the point of engagement and point of entry. This facilitates gathering real time data on users, customers or other people during engagement with elements of the system to provide analytics in real time. The problems associated with the need to donate to charities efficiently through vending are also addressed.

### BRIEF DESCRIPTION OF THE DRAWINGS

The proposed method and apparatus is best understood from the following detailed description when read in conjunction with the accompanying drawings. The drawings include the following figures briefly described below:

FIG. 1 shows an exemplary architecture of a system for implementing product sales from interactive vending machines employing the present principles.

FIGS. 2A and 2B are schematic views of a vending machine of the present principles which employ transparent LCD layers and touch screens.

FIG. 3 is an exemplary flow chart of a mode for enticing individuals to engage a system and to allow for data gathering and data analytics employing the present principles.

FIG. 4 is an illustrative drawing of a vending machine in accordance with the disclosure.

FIG. 5 is a flow chart of preferred methods of the disclosure.

FIGS. 6A and 6B are alternative embodiments of a vending machine in accordance with the disclosure wherein rows or columns of the vending machine may be designated as selections for charity, or wherein different selections areas may be designated as contributing to charity or otherwise allocating part of the purchase price to charity.

It should be understood that the drawing(s) are for purposes of illustrating the concepts of the disclosure and is not necessarily the only possible configuration for illustrating the disclosure.

### DETAILED DESCRIPTION OF EMBODIMENTS

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Any element expressed, or which ultimately might be construed, as a means or step for performing a specified function is intended to encompass any way of performing that function including, for example, a) a combination of circuit elements that performs that function or b) software in any form, including, firmware, microcode or the like, combined with appropriate circuitry for executing that software to perform the function. It is intended that the functionalities provided by the various recited elements will combined and brought together in a manner understood by those skilled in the art, and by any means or steps that can provide those functionalities, and their equivalents.

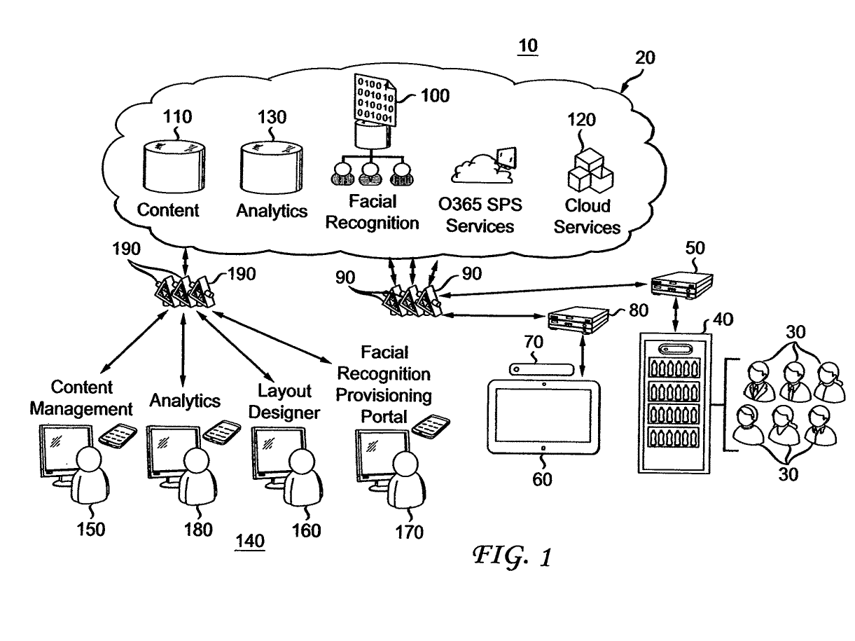

Referring to FIG. 1, an exemplary system architecture 10 of this disclosure implements a cloud-based analytical environment 20 that allows users, customers of other people 30 (hereinafter referred to as “users”) to interact with a vending machine 40, for example, so that ultimately the users 30 can purchase products from the vending machine 40. It will be appreciated that other products, or indeed services, could be sold to users 30 from machine 40. It will also be appreciated that while the analytical environment 20 is shown as being cloud-based, this environment could also be implemented in a self-contained network such as a LAN, WAN or through elements of the Internet in combination with the Internet, the cloud or other elements of a computer-based network.

Vending machine 40 is equipped with the appropriate modality to interact with the Internet, either through a wireless connection 50 or through an Ethernet or equivalent type of communication bus. Other communications devices, for example a screen, television, or other type of display device 60 and a camera 70, may also be used to allow users 30 to interact in the system 10, and are also able to communicate through a wireless device 80 or other communication bus. The screen or television 60 and camera 70 allow user profiles, to be described in more detail below, to be gathered and processed as the user engages in the shopping and purchasing process, and further facilitates data gathering opportunities for the system 10. The users may optionally be given access to a variety of apps 90 which also facilitate and allow interaction in the system 10 with the cloud-based environment 20.

In accordance with some of the principles of the disclosure, and as mentioned above, the architecture of FIG. 1 provides solutions to the problems in the art regarding identifying and seeing people interacting within range of the vending machine 40, camera 70, which for example could be a 3D camera, or with other particular devices in the environment of architecture 10. The system thereby provides, for example, demographic tracking of users' age, race, gender, and other salient demographic data. Facial Identification is provided which will allow the system to identify users that have appeared before, or interacted with, as well as facial recognition wherein the user opts-in to be recognized by the system.

More subjective data points may be quantified by the system architecture of FIG. 1, for example, the emotional satisfaction of a user which may be tracked during interaction with the system to determine whether the user is happy when viewing an ad or content. Engagement tracking, that is whether a user's eyes are engaged with the content or looking away may be tracked, and the number of viewers and the level of engagement that they have with the platform may be quantified. More simple analytics may be gathered, for example, the counting of people that come in “site” of the system, which in and of itself is a very useful set of data that may be provided to vendors or advertisers, for example. By providing the ability to gather the above mentone data, and indeed other types of date, the system of the present disclosure provides an efficient and cost-effective tool to develop argeted content or advertising based on any of the tracking categories delineated herein.

In a preferred aspect of the disclosure, the Microsoft Azure™ (trademark owned by the Microsoft Corporation of Redmond, Wash.) is used to implement the cloud architecture 20. Within the cloud 20, the principles of the disclosure provide for facial recognition processing and data reduction 100, and the modality to implement content 110 so that a designer of a custom system of the present principles can provide both interactive and non-interactive content groups. This may allow for sophisticated multi-screen spanning, which will allow the content and touch to span unlimited large form factor screen devices 60. Moreover, it is possible to tracks at least six users at a time during facial recognition 100 to measure their engagement, emotion, demographic profile (age, race, gender, etc.) as they interact with the system. Additionally, the system 10 is provided with cloud services 120 that contains the necessary components and data infrastructure to gather and persist demographic and usage data into the cloud databases that will store the data, and store the analytically reduced parameters that may be acquired from the data according to the particular needs of the advertiser or vendor, for example.

As will be further appreciated, the system design provides the necessary engineered solutions for an analytics module 130 to engage in fault tolerant and properly scaled local services that are ultimately engaged in the cloud services module 120. This will allow for synchronized content of the end devices, and the proper gathering of analytics from these endpoints by the analytics module 130. This will also allow for the performance of proper facial recognitions and demographic profiles in real time. To ensure a secure web portal and safe content management system and reporting, the architecture 20 is preferably hosted on a Microsoft Office 365 SharePoint™ (trademark also owned the the Microsoft Corporation of Redmond, Wash.) host server). The architecture advantageously allows campaign and day-parting of advertising based on demographic profile.

In order to properly interface with the cloud 20 and design customized systems to satisfy the needs of any advertiser, vendor or entity that requires the data gathering capabilities and analytics of the present disclosure, a backend portion 140 is provided to allow for system design. Backend portion 140 radically alters the prior methodology and delivery modality of legacy systems while capturing demographic and consumer behavior in the finest detail. Backend portion 140 addresses many important and salient design and feature objectives. Backedn portion 140 is essentially a “what you see if what you get” (WYSIWYG) screen layout editor that provides flexibility in design and ease of use for custom application of system 10.

For example, the software which is used to implement backend portion 140 is optimized for low cost, generic computing platforms, and may utilize commercial off the shelf systems, for example low cost Windows' (trademark owned by the Microsoft Corporation of Redmond, Wash.) embedded operating systems. Thus, the software use is oriented around “touch” and/or “gesture” and/or “voice recognition” interfaces, and provides for management of all types of digital assets, web content, structured data, and virtual objects in both 3D and 2D. The software can content manage data, assets and images from foreign systems, and is flexible in terms of size and interactive regions to display content.

Moreover, the software is multi-platform and is able to be displayed on mobile or large form factor screens or even run “headless” in facial recognition modalities. Additionally, the software leverages the cloud infrastructure 20 for hosting of centralized digital assets with fault tolerant and scalable cloud services that synronize content to local devices, as mentioned above. This allows for simple, scalable and wide spread content updates across multiple platform locations and end points. As discussed above, the backend platform 140 also provides for a sophisticated content management system 150 design function and a layout designer 160 function as a service or as a self-service, for example. A facial recognition portal 170 allows the designer to interact with facial recognition analytical functions 100 in the cloud 20, and an interactice analytics functions 180 also is interfacable with the cloud 20. As will be appreciated, a secondary series of apps may also be accessible by operators in the backend platform to interface as is desired with functional aspects of the features of the architecture 10 in the cloud 20.

The software running the backend platform 140 may be built and presented in Windows Presentation Foundation (WPF), which is a graphical subsystem for rendering user interfaces in Windows-based applications. WPF, previously known as “Avalon”, was initially released as part of .NET Framework 3.0. WPF uses DirectX for vector based graphics and other advanced graphical capabilities. WPF employs XAML, an XML-based language, to define and link various interface elements. WPF unifies a number of common user interface elements, such as 2D/3D rendering, fixed and adaptive documents, typography, vector graphics, runtime animation, and pre-rendered media. These elements can then be linked and manipulated based on various events, user interactions, and data bindings. WPF runtime libraries are included with all versions of Microsoft Windows since the advent Windows Vista™ (trademark of the Microsoft Corporation of Redmond, Wash.) and Windows Server 2008™ (trademark of the Microsoft Corporation of Redmond, Wash.).

With the system architecture of FIG. 1, a completely flexible, interactive digital signage environment is achieved. Demographic profile options preferably use a 3D camera 70 to produce profiles based on age, gender and ethnicity. This demographic profile data is persisted in cloud databases 120 for analytics reporting. Dwell time and emotion recognition is also captured. Other features include campaigns based on day-parting. Custom content 110 based on a demographic profiles may also be persisted and displayed, and, the connection between public engagement and analytics, happen in real time. Preferably, facial recognition to handle both loyalty programs and security scenarios is also achievable. Additionally, the present architecture 10 allows running of a security embodiment “headless”, that is, no large form factor screen is used for running interactive digital signage. In this embodiment, the includes 3D camera 70 for facial recognitions with speed, accuracy and scale. Advantageously, the system may be used by independent custom developers to enhance and extend, the system with custom software for purpose built applications, and may be implemented with content management system self-management capabilities for customers that desire a self-serve function. Additionally, a software as a service (SaaS) context may be implemented in accordance with the principles of the disclosure, which may include hosting for a monthly fee.

Those with skill in the art will therefore appreciate that systems designed in accordance with the principles of the present disclosure can gather data never before captured at the point of engagement or point of entry. This facilitates real time gathering of data on the user, for example their identity, age, gender, ethnicity, dwell time, emotion recognition, and security threat. Coupled with the use of advanced optical displays to be described in more detail below, the connection between public engagement and analytics happens in real time. These results have not heretofore been achieved in the art, and provide solutions to the long-felt and unfulfilled needs which exist with current data gathering systems today.

As mentioned above, advanced optical displays are integrated into the system of FIG. 1, and may be placed on, for example, the vending machine 40 to implement the data gathering and tracking features of the disclosure. Such optical displays are known in the art, and use advanced optical bonding techniques. An example of such an optical bonding technique to produce advanced displays is illustrated in U.S. Pat. No. 6,961,108 Wang ET al., the teachings of which are specifically incorporated herein by reference. Other, more recent examples of LCD displays incorporating advanced optical bonding techniques are found in U.S. Pat. No. 8,462,301 O'Donnell, the teachings of which are also specifically incorporated herein by reference.

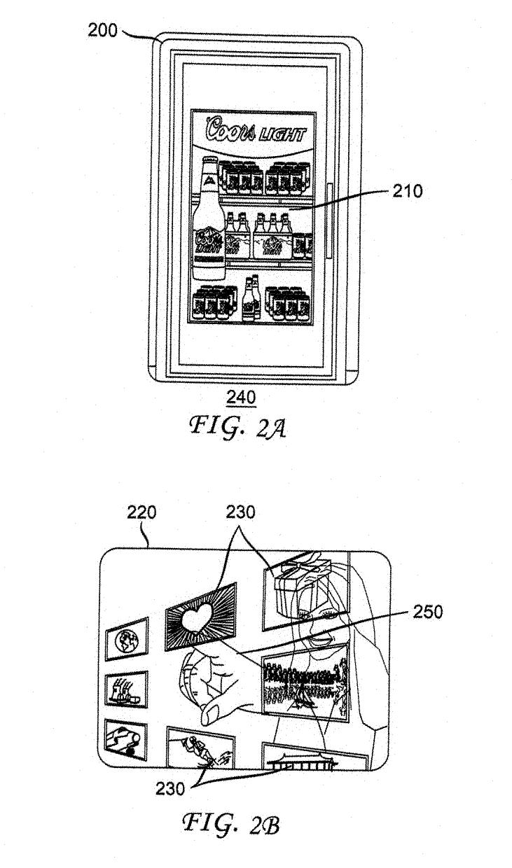

Referring to FIGS. 2A and 2B, an exemplary vending machine 240 (shown particularly in FIG. 2A), is illustrated and which may be used in the system of FIG. 1 as a replacement for, or in addition to, vending machine 40. Machine 240 has a conventional cabinet 200, in which a freezer unit, refrigerated unit, or other vending unit (not shown) is housed, and from which products or services may be vended. As has been described above, users of the machine will, in the normal course of the machine's placement in an area, public or otherwise, traverse in and around machine 240 and may wish at some point to purchase products or services from machine 240. It would be desirable to employ a function within or around machine 240 to attract the users' attention to the machine, its products or services, to entice the users to purchase the products or services

In order to entice the users to the machine 240, attached thereto is an LCD panel 210 which is transparent, and which can have displayed thereon advertisements which are attractive, evocative, and which can draw users to the machine to advertise the machine's products or services. Such advertisements may be animated, computer-generated, and/or interactive. Moreover, the LCD panels 210 may further contain interactive touch screens 220 (shown particularly in FIG. 2B), either as part of the LCD panel 210, as portions thereof, or as separate LCD screens also appended, attached or otherwise associated with machine 240. The touch sensitive panels 220 may themselves contain one or more touch sensitive icons 230 which may be interactive with the user by touching icons 230, as shown generally at 250.

Several hardware suppliers introduced transparent LCD screens in various sizes which can be used to implement vending machine 240 with touch sensitive LCD panel 210 and touch screen 220. One such supplier is the OPTIKA Display Solutions Company of Los Angeles, Calif. This technology allows for the placement of a RD capable video screen in the form factor of a door. This technology, with adjustable transparency, has delivered digital capabilities to cooler and freezer doors and provided ways whereby promotions can be delivered in store to captive audiences. With the integration of the software CMS solution of FIG. 1, and the vending machine 240, high impact visual capabilities may be delivered directly to an in store consumer.

Thus, the present disclosure implements principles that extend beyond basic digital signage and include HD quality video (the ability to play multiple videos simultaneously), adjustable opacity (in order to modify transparency based on the nature of the content) touch screen integration ,which is a software solution that allows for the creation of unique interactive content ,day parting, which is the ability to change the entire content set on a time of day basis, and camera integration, which is the ability to have an integrated camera designed to play content that is meant to entice consumers to approach and interact with the content.

In conjunction with these important features and advantages, the system 10 and vending machine 240 also allow for extensive reporting that includes proof of play reporting (to demonstrate to an advertiser that their advertising has played, and how many times it has played), demographic triggering, which is the ability to play content based upon what the camera sees (age, gender, etc.), and in store reporting including multiple criteria of reporting, key relate elements of which include, for example, Total Brand Impressions, Total Brand Engagements, Total Interactions, the number and identity of unique visitors, the number and identity of returning visitors, the dwell time of visitors, and the race gender, age and emotional engagement of the visitors.

A primary application of system 10 and vending machine 40, 240 is the delivery of a digital signage to a location and within a context where none before existed, and to make that medium a compelling way to deliver promotions and information to consumers and users. This helps consumer packaged goods companies deliver a “brand experience” to a location where a consumer or user is in a position to act on that message. The system of FIG. 1 leverages camera technology to gather meaningful information in real time from the point of sale. This data collected not only provides the advertisers the ability to measure campaign effectiveness, but the brand can get invaluable insights as to the nature of their consumers and users, including buying behavior, demographics, and never before seen consumer data; all in real time. No prior systems combine digital signage with data collection. The systems employing the present principles provide the ability to deliver key messaging at point of sale, which is critical to the value equation. Such results have not been heretofore achieved in the art.

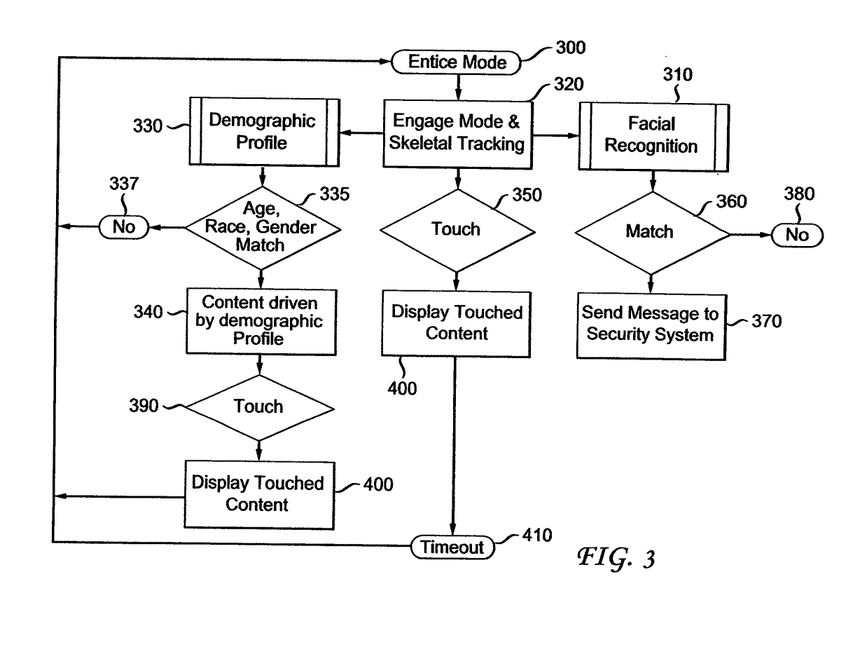

Referring to FIG. 3, a flow chart illustrating the present data gathering and analytical principles is illustrated. These principles utilize the vending machine 240 as described, but are equally usable in other applications for other uses of the touch sensitive, transparent LCD panels discussed above. Entice Mode 300 is an engaging and eye catching content delivery function that runs until the 3D camera 70 identifies one to many users that are interacting with the system 10. The 3D camera 70 does a skeletal map of the person(s) to determine the Facial Recognition 310 of the persons, and then the system switches into Engage Mode and Skeletal Tracking 320. Once skeletal tracking identifies the faces camera 7 identifies, the system rapid fires pictures of the faces (even while the people are moving) to the cloud API. The pictures are decomposed into a physics mesh and thrown away. The algorithms are run on the meshes for facial recognition and to produce Demographic Profile 330.

If the demographic profile matches the targeted demographic by age, race, gender, etc. 335, then the standard campaign driven content is swapped out for custom content based on the demographic profile 340. If not at 337, then the system reverts to Engage Mode 300. However, if the user touches the transparent glass 350 after having been matched, then the Interact mode is triggered switching out from Engage Mode 300. If the Facial Recognition 310 engine produces a match 360 the alerts are sent to the security system(s) 370, otherwise no match of the user is found 380.

Then, if the demographically profiled user engages in the content by touching 390 the transparent glass then Interact mode is triggered, switching out from engage mode providing custom content 400 to the demographically targeted user. After the user walks away, the system reverts back into Entice Mode where the process starts all over again. If no action is resolved by the system 10, then the systems may timeout 410, and revert to Entice Mode to start again.

It will be appreciated that other retail and public environments suffer the data gathering, tracking and analytics problems that the present principles address and solve. For example, higher end liquor, both wine and spirits, are often displayed at retail in custom point of purchase display constructions. In many cases brands will create custom display cases in order to help their product stand out and to provide a luxury brand impression in store. In accordance with the present principles, both displays and cameras can be added to these points of purchase display units to capture information on individuals accessing the unit that is now unlocked and accessible to any and all customers. The technology can be equipped to capture a photo when a customer approaches, when a customer accesses, or when a customer grabs a product. A message, along with a photo, can be instantly and securely provided to a designated person or persons at retail. Gathering this information acts as a theft deterrent, particularly since it provides a surveillance element that is “in context” directly at retail. But, in addition to the core application, it also provides brands with instant and continuous in store data. This solution can be sold in conjunction with digital signage and display (a point of purchase display with a LCD screen providing brand information) or simply as a camera solution not necessarily tethered to display.

Machine learning has advanced enormously in the past few decades. The same basic technology that allows a car to drive itself is responsible for ancillary development in unrelated technology arenas. Machines are now capable of interpreting data not just recording and analyzing data. The present principles will allow casino operators to deploy additional camera technology at eye level (ideally in conjunction with digital signage) to pro-actively scan crowds of people for persons that have been entered into the “watch list”. This application, coupled with machine learning capabilities now being developed, will provide the casino operator with abilities to track and safeguard their casinos. Unlike other forms of facial recognition technology, the present principles can track people while they are moving though public spaces. Prior imaging techniques require persons to stand at a kiosk while their image is captured and compared. This approach to casino security is awkward, and cannot provide the required unobtrusive tracking that is required in the casino environment to allow the casino to run smoothly, without disruption. The present architecture allows for scanning a crowd looking for bodies (separating bodies from objects) and discerns where the face is on a given body. Once the face is captured the facial recognition lookup can occur. This all happens in milliseconds and allows the system to scan large crowds of people in real time.

The present system uniquely merges of a security application with a digital signage application in a manner that enhances both applications. A facial recognition application that merely scans the crowd has a certain value but, when added to digital signage, the solution'becomes even more compelling. The digital signage content is created to draw the attention of the audience. A facial recognition application that is designed to draw attention (by applying a creative treatment to the digital signage) will, by definition, be more effective as people are more likely to look directly at the signage (thereby increasing efficiency and accuracy).

The current principles are well applicable to integrating emotional detection into a software solution. In addition to detecting such emotional responses like smiling, frowning, the present architecture will bring great advances in being able to sense a person who is exhibiting visual cues of stress is the promise of this technology, which has not been possible in the past.

The present principles may also be extended to the application of plucking faces from real time video. This means that the multiple video feeds that today are gathered and delivered in real time can be filtered through the present processes that will, in real time, pluck individuals out of crowds to provide alerts on possible restricted or sought after individuals. Such an application will be usable to analyze video from one or many legacy or existing sources.

It can be said that with facial recognition a person's face is his or her identity. Based upon a consent and opt-in process, individuals wishing to be offered promotions at point of sales can do so. The present platform can identify an individual to offer on the spot promotions with full knowledge of that specific customer's buying preferences. The customer relinquishes anonymity but receives discounts and offers in return. The result is that loyalty/identity is determined prior to check out. This makes driving context and campaigns that are valuable to the customer a possibility.

When cameras are placed in conjunction with digital signage critical objectives may be achieved. For example, compelling content displayed on digital signage will draw the eyes of the audience, which is highly important in achieving the desired recognition that the owner of the signage wants to accomplish. This drastically increases the number of people that look at the signage, even if only for a brief time. Another critical objective is achieved since the angle of attack is vastly superior with the camera being co-located with the signage. Both of these factors, taken together, increase the accuracy and the hit rate of the present systems in crowd scanning technology. While it is desirable to get a clean frontal face view, the present architecture need only acquire a portion of the face to determine an accurate match. A probability score is provided with each match, which allows an appropriate response to be actioned. Assuming good camera placement (in areas where traffic flow is constricted to a specific and defined path) the present system can scan hundreds of individuals very efficiently. This leverages a highly scalable local or cloud based database that is populated with basic biometric data of known persons.

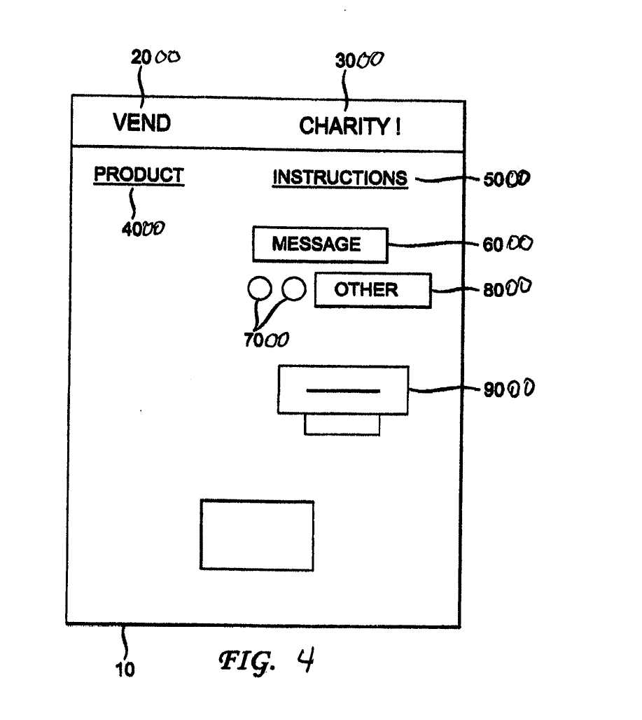

FIG. 4 shows a vending machine 1000. Machine 1000 is any kind of machine that dispenses products or services for a fee. Soft drink machines, personal products machines, candy or snack machines, consumer products machines, arcade game machines, service dispensing machines, for example, video or audio services, are all intended to be within the scope of the disclosure. For purposes of the following description, a soft drink dispensing machine will be described.

As mentioned above, such machines 1000 typically vend products or services for money. Money in the form of currency (coins or paper) may be used to vend a product, or a credit or debit card may be used to obtain the product. Additionally, a “mobile wallet” may be employed to effect payment. A mobile wallet is a device which a user or customer carries that may be linked to a wireless access on the vending machine (not shown) so that the user or customer can pay for products. A mobile phone, tablet, personal digital assistant (PDA), laptop computer or other handheld or mobile device may have mobile wallet functionality. Generally, mobile wallets effect payments either through direct mobile billing, SMS transactional payments, mobile web payments, or other emerging modalities. In yet a further preferred embodiment, one-swipe of a debit or credit card may occur and multiple transactions can be implemented. In this case, a consumer may purchase a beverage, for example, and there are monies (“commissions”) paid from the owner of the machine such that multiple accounting occurs facilitating a portion to the charity and possibly a portion to the sponsors of the machine. This is done without impacting the vend price or prompting the consumer to do anything. With such a “one-swipe” transaction, the single swipe transacts between otherwise un-linked entities such as the charity and the owner, or yet other third parties. In any case, it would be desirable to couple in some manner the vending and payment of the product to a charitable donation made through the use of machine 1000.

Thus, the machine 10 may have an identifier 2000 on an advertising to tell a purchaser what kind of product or service is being purchased. In proximity to the identifier 2000, an identification of the charity 3000 may also be placed on an advertising portion of the machine 1000. It will be appreciated that the identifiers 2000 or 3000 may be on any place on the machine, or even only in association with the machine 10 in proximity thereto, but not necessarily physically located thereon. Yet further indications 4000 for specific products may be similarly located, so for example identifier 4000 may be specifically for COKE® (a registered trademark of the Coca-Cola Company, Atlanta, Ga.). It will be further appreciated that non-visual identifiers such as sound, music, smells or tactile devices may also be used to identify to consumers that a charity may be benefitted or that a product or service is available to the consumer through the vending machine. Moreover, such labels or signage may further include references to websites which will allow customers to obtain information on the charities so that the customers can be fully informed about the charities to which they may contribute.

It will be appreciated that other types of instructions 5000 may be appended or in proximity to the machine 10, and such instructions could, for example, explain to consumers that they have the opportunity to contribute to charity through use of the machine 1000. Other instructions for the use of the machine may also be placed in this type of arrangement.

Once the customer or consumer selects a product, message center 6000, typically a LED readout, asks the consumer whether they would like to contribute to charity. In the case when currency has been used, for example, a set of buttons 7000 may be provided to give the user a yes or no option if they would like to have the “change” be given to the charity as listed on the machine, or in the case of credit card that the transaction is rounded up to the next whole dollar and one transaction takes place. If no LED is available then this can be accomplished through signage on the machine. This signage would provide easy instructions on how to donate change or other amounts to charity.

Another possibility is provided through an “other” device 8000 which, in the case of credit card use, allows the consumer to add additional amounts to be donated, or if cash is to be used, allows the user to place more cash in the coin slot on the machine 1000. The other device 8000 may be a keypad or device which provides the ability for different amounts to be donated. As is conventional, a credit/debit card reader and coin or bill acceptor 9000 is provided to allow the user to make payments for products or services, or to make donations. Either an internal computer processor (not shown) or an external connection to an external computer processor (also not shown) will be provided to provide for the proper accounting of the payment for the product or service, as well as the required allocation of funds donated to the charity, less any type of service fee required for doing so. In this manner, the disclosure would then be able to reconcile the amounts that were for product purchases and the amount to be given to the charity. This could be done for any type of machine vending i.e. beverage, food, movies, papers, etc.

An important aspect of the disclosure is alerting the consumer through visual identifier 30 on the machine the particular charity or charities that may be sponsored and asking a simple question through the LED display 60 after the product selection. This prompting could also be done prior to the product selection. The charitable donation could then be given in the name of the sponsor of the machine. Moreover, it will be appreciated that more than one charity may be donated to, and the functionality of the disclosure will provide for allocations of change or different amounts, for example in percentage form, to be so allocated to different charities as the consumer so desires, and as is made available on the particular machine from which purchases are vended.

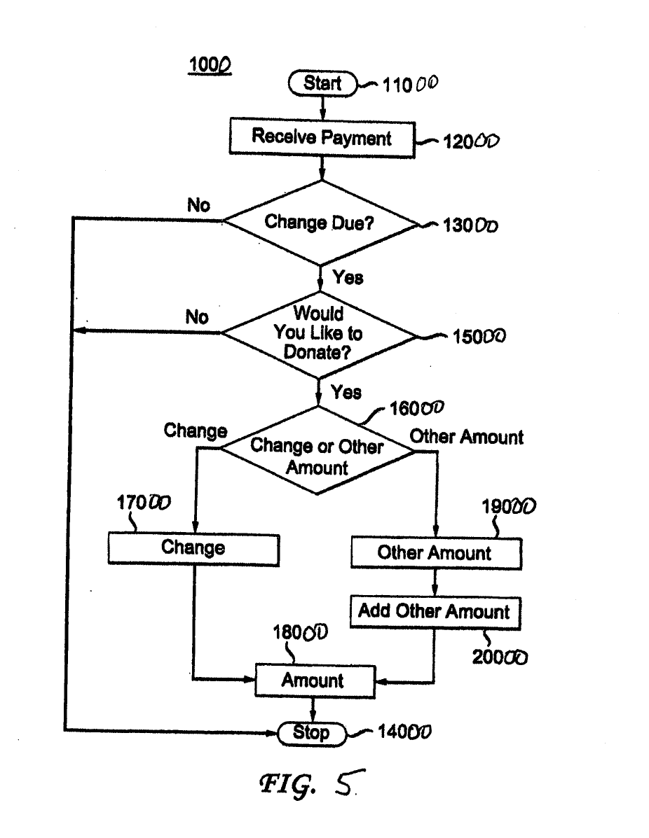

Referring to FIG. 5, a flow chart of an exemplary method in accordance with the disclosure is shown at 10000. Such methods can be implemented in software, firmware, hardware or any other modality for use in conjunction with a computer processor as will be appreciated by those skilled in the art. The method starts at step 11000, and at step 12000 payment is received by the vending machine. The method then determines at step 13000 whether change is due on the transaction, particularly if cash has been used. If not, then the method stops at 14000. At this point, the method may query the consumer if it wishes to make a donation at step 15000. If not, then the method also stops at step 14000.

However, if the consumer wishes to donate to the charity, at step 16000, it is determined, either by asking the consumer or otherwise, whether the consumer wishes to donate the change, or some other amount. If the consumer wishes to donate the change, then at step 17000 this amount is the amount to be donated, and an accounting function is implemented at step 180, as discussed above. The method then terminates at step 14000.

It is then preferably determined at step 19000 whether some other amount to be donated is desired, and if so then at step 20000 the other amount is determined and added. This could be a simple rounding up of the transaction to the next dollar, or to some other amount specified by the user. The method could even suggest an amount to be donated. One this amount is determined at steps 19000 and 20000, the consumer would be prompted, for example, to allow the credit or debit card to by charged this additional amount in addition to the price of the product, or to submit more or additional cash to the cash acceptor 9000 on the machine 1000. The method then accounts for these amounts at step 18000, and terminates at step 14000. In this manner the change or additional donation is “rounded-up” for the charity, and charitable donations are advantageously collected and donated.

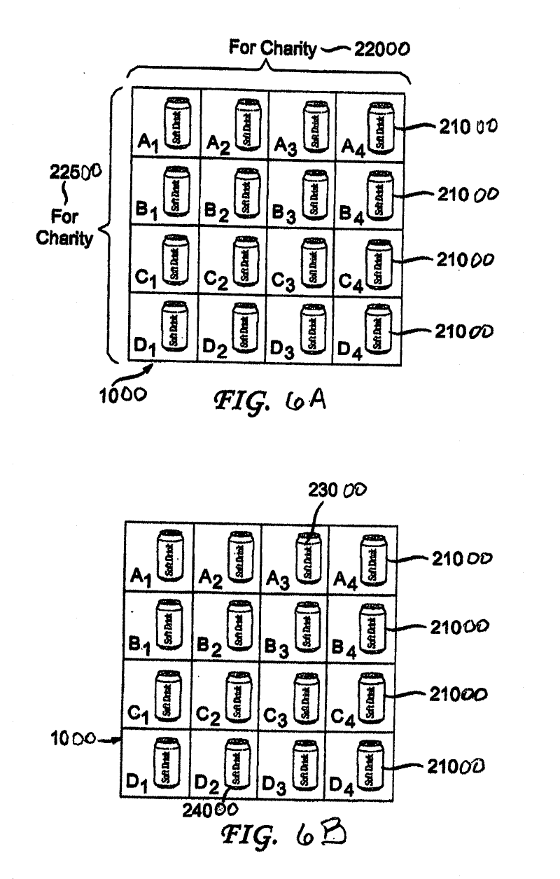

FIG. 6A shows a vending machine 1000 wherein product positions are arranged by row and column. Thus, A1, A2, A3, A4 . . . D3, D4 are all specific locations which may conventionally be chosen by a customer and which contain unique products 21000 for vending from the location when the selection is made and paid for by the customer. In a preferred embodiment a row 22000 or column 22500 can be programmed by the internal or external processor or by the credit/debit card reader, or otherwise, to designate that all of the products from row 22000 or column 22500 will be rounded up to the nearest dollar relative to the selections and these rounded up monetary amounts will be designated for the charity. The software diagram of FIG. 6A may be modified to achieve this result, for example at steps 15000 and 16000; the software functionality may be modified to specify the row or column for which this is desired. It will be appreciated that such row or column can be modified by the owner or operator of the vending machine as the owner or operator so designates. Moreover, different or multiple charities may be designated by the consumer.

FIG. 6B illustrates yet a further preferred embodiment of the inventive vending machines wherein separate selections locations or areas A1, A2, . . . D3, D4 may be designated 23000 (in this case location A3) or 24000 (in this case D2) as specifically allocating an amount to be donated to charity and to be paid for along with the product selection. For example, A3 may be chosen by the consumer and then a further selection will be made of A3 or D2 wherein A3 will donate $1.00 to charity and D2 will donate $0.50 to charity. Any such separate selection may be programmed as described herein, modified as desired by the owner or operator of the vending machine 1000, or otherwise specified for multiple amounts, multiple different charities, and different product purchases. In this fashion, not only are different amounts for charities associated with different products programmable, but also multiple charities may benefit in a single vending machine environment. It will be appreciated by those with skill in the art that other embodiments which are variations of those described herein are possible.

There have thus been described certain preferred embodiments of vending machines for rounding-up donations to charity in accordance with the present disclosure. While preferred embodiments have been described and disclosed, it will be appreciated that modifications are within the scope of the disclosure. The appended claims are intended to cover all such modifications.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the proposed method and apparatus is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (PO) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

It is to be further understood that, because some of the constituent system components and method steps depicted in the accompanying figures are preferably implemented in software, the actual connections between the system components (or the process steps) may differ depending upon the manner in which the proposed method and apparatus is programmed. Given the teachings herein, one of ordinary skill in the related art will be able to contemplate these and similar implementations or configurations of the proposed method and apparatus.

What is claimed is:

1. A method of vending a product or service from a vending machine having a plurality of vending locations in rows and columns and a processor for performing the method, comprising:
determining from the plurality of vending locations from which a product or service will be vended, locations further comprising at least a row or a column designated to give a consumer an option to contribute money to a charity in conjunction with purchase of a product or service and the locations still further comprising at least one other row or one other column that does not allow for a donation to a charity in conjunction with the purchase of a product or service, and wherein the product or service is located in the row or the column designated to allow for a donation;
specifying a row or column in which a charitable donation may be made in conjunction with the purchase of the product or service;
sending a message which asks the consumer whether the consumer wishes to contribute to the charity in conjunction with the choice of a vending location from the designated rows and columns;
determining whether the consumer has chosen a product or service to be vended from a row or column that has been specified and that allows for donation to the charity in conjunction with the purchase;
upon determining that a row or column has been chosen by the consumer that allows purchase of a product or service that also allows contribution to the charity, processing payment for the product or service to be vended by the vending machine and allow the consumer to make charitable contributions in an amount designated by the consumer to the charity after the purchase has been chosen by the consumer;
performing a multiple accounting to allow for more than one un-linked entities to receive payments in connection with payment for the product and the donation to the charity, the un-linked entities being the charity and at least one of a group comprising an owner of the vending machine and a third party;
allocating the payments between the charity and the un-linked entities and reconcile the amounts that were for the product or service purchased from the vending machine, the donation to the charity and the payments to the third party; and
upon receipt of the payment form the consumer at the machine for the product or service chosen by the consumer which include the allocation between the charity and the un-linked entities, causing the vending machine to vend from the location in the machine without any prompting from the consumer the product or service chosen by the consumer from the specified row and column of the vending machine to complete the purchase;
communicating through a wireless access point in communication with the processor at least one of the purchase and the charitable contribution;
delivering content to the user from a digital sign which will entice the user to engage the system in an environment in which the user can be visually tracked;
mapping the user's physical attributes to determine a facial recognition of the user and to identify the user;
decomposing facial recognition attributes of the user into a mesh of features and storing the mesh of features for the user;
applying a demographic profile to the stored mesh features of the user; and
swapping out the content delivered to the user from the digital sign with demographically driven content to further entice the user to engage the system.
